(19) United States
(12) Patent Application Publication
(10) Pub. No.: US 2013/0226484 A1
(43) Pub. Date: Aug. 29, 2013

(54) METHOD AND APPARATUS FOR GENERATING POWER FLOW SIGNATURES

(71) Applicants: Markku Antti Kyosti Rouvala, Helsinki (FI); Leo Mikko Johannes Karkkainen, Helsinki (FI)

(72) Inventors: Markku Antti Kyosti Rouvala, Helsinki (FI); Leo Mikko Johannes Karkkainen, Helsinki (FI)

(73) Assignee: Nokia Corporation, Espoo (FI)

(21) Appl. No.: 13/405,917

(22) Filed: Feb. 27, 2012

(51) Int. Cl. G06F 19/00

(52) U.S. Cl. 702/61

(57) ABSTRACT

An approach for enabling identification of different types and sources of power being distributed over an electrical power grid is disclosed. An energy management module determines one or more power flows transmitted over at least one electrical power grid. The energy management module then causes a encoding of one or more identification signals into the one or more power flows. The one or more identification signals distinguish the one or more power flows from one or more other power flows transmitted over the at least one electrical power grid.

### BACKGROUND

Electrical power grid providers typically receive power from a number of different sources and energy providers. Consequently, power flows into the electrical grid may be based on the conversion and processing of different forms of energy. For example, the grid provider may procure power from a windmill farm that generates electricity based on wind or from a solar farm that converts solar energy into electricity. Other energy providers may include nuclear energy plants, coal processing plants and the like; all of these sources being configured to channel power to the grid via a network of power transmission equipment. Typically, the amount of power output by the respective energy providers can be measured prior to the power being conveyed from the plant to the electrical grid for distribution. Once the power is channeled to the primary high voltage, low voltage, industrial or town/area grid distribution equipment, however, only the combined power signal (waveform) is detectable.

Unfortunately, there is no way for consumers receiving power via an electrical grid to separate the power signal into distinct waveforms for identifying the source or type of power being supplied. This limits the ability of consumers to identify or manage their energy use with respect to the available different forms, sources or energy providers from which they may receive (e.g., wind versus nuclear) power. Also, the electrical power grid provider is unable to generate adequate metrics regarding consumer energy preferences as well as real-time feedback on the use and consumption of different types and sources of power by the consumer.

### SOME EXAMPLE EMBODIMENTS

Therefore, there is a need for an approach for enabling consumers to identify the different types and sources of power being distributed over an electrical power grid.

According to one embodiment, a method comprises determining one or more power flows transmitted over at least one electrical power grid. The method also comprises causing, at least in part, a encoding of one or more identification signals into the one or more power flows, wherein the one or more identification signals, at least in part, distinguish the one or more power flows from one or more other power flows transmitted over the at least one electrical power grid.

According to another embodiment, an apparatus comprises at least one processor, and at least one memory including computer program code for one or more computer programs, the at least one memory and the computer program code configured to, with the at least one processor, cause, at least in part, the apparatus to determine one or more power flows transmitted over at least one electrical power grid. The apparatus is also caused to encode one or more identification signals into the one or more power flows, wherein the one or more identification signals, at least in part, distinguish the one or more power flows from one or more other power flows transmitted over the at least one electrical power grid.

According to another embodiment, a computer-readable storage medium carries one or more sequences of one or more instructions which, when executed by one or more processors, cause, at least in part, an apparatus to determine one or more power flows transmitted over at least one electrical power grid. The apparatus is also caused to encode one or more identification signals into the one or more power flows, wherein the one or more identification signals, at least in part, distinguish the one or more power flows from one or more other power flows transmitted over the at least one electrical power grid.

According to another embodiment, an apparatus comprises means for determining one or more power flows transmitted over at least one electrical power grid. The apparatus also comprises means for causing, at least in part, a encoding of one or more identification signals into the one or more power flows, wherein the one or more identification signals, at least in part, distinguish the one or more power flows from one or more other power flows transmitted over the at least one electrical power grid.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling consumers to identify the different types and sources of power being distributed over an electrical power grid, according to one embodiment;

FIG. 2 is a diagram of the components of an energy management module, according to one embodiment;

FIGS. 3A-3D are flowcharts of processes for enabling consumers to identify the different types and sources of power being distributed over an electrical power grid, according to one embodiment;

FIGS. 4A-4E are diagrams of user interfaces utilized in the processes of FIGS. 3A-3D, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for enabling consumers to identify the different types and sources of power being distributed over an electrical power grid are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

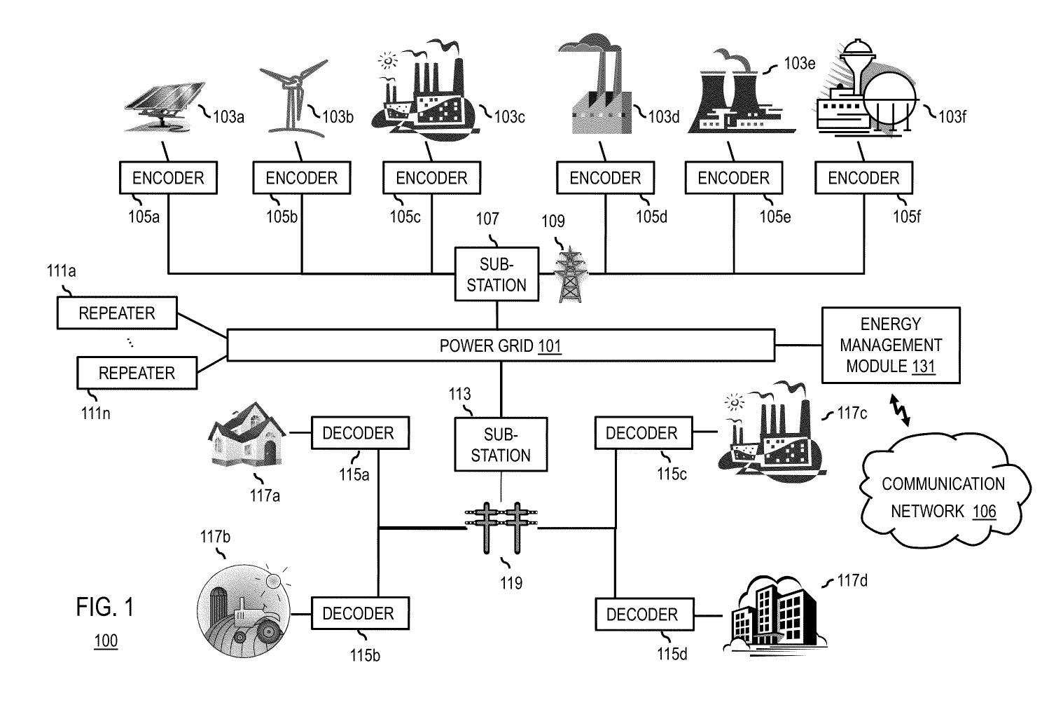

FIG. 1 is a diagram of a system capable of enabling consumers to identify the different types and sources of power being distributed over an electrical power grid, according to one embodiment. By way of example, the system 100 includes an energy management module 131 that is configured to aggregate feedback data regarding current consumer power usage, power source types and preferences related thereto pertaining to a power grid 101. In addition, the energy management module 131 is integrated for use in connection with the power grid 101 for supporting identification of one or more power flows transmitted over the grid 100 by the consumer. In certain embodiments, this includes the presenting of relevant information via a user interface regarding the distinct signals (waveforms) comprising the power signal distributed over the grid 101.

Electrical power grids 101 typically include a network of distribution equipment (e.g., distribution substations 113), transmission lines 109 and 119, transformers and transformer poles for conveying power to consumer sites 117a-117d throughout a given geographic area. Power is supplied to the grid 101 by different energy providers, i.e., power plants that generate electrical power through the conversion and processing of different sustainable or man-made resources. For example, the grid 101 may interface with an independently owned windmill farm 103b that generates power from wind energy, a solar farm 103a equipped with a multitude of photovoltaic cells for generating power flows from solar energy, a hydro energy plant 103f that converts water into electrical energy, a nuclear plant 103e, a coal processing facility 103d, an industrial power plant 103c, etc. Each of these independently owned and operated energy providers channel power to the grid 101, at varying output power levels, using power coupling and transmission equipment (e.g., transmission substations 107).

Typically, the amount of power output by the different energy providers can be measured prior to channeling of the electrical power onto the grid 101 for distribution. Hence, the power flows are transmitted to and subsequently distributed over the network/grid 101, which may include various interconnected high voltage, low voltage, industrial or town/area distribution equipment. As a result, however, only a single power signal is capable of being measured as output from the grid even though the grid power flow is the result aggregate of multiple different power flows. Unfortunately, there is no way for consumers to separate the signal into the distinct waveforms associated with each individual energy provider.

To address this problem, a system 100 of FIG. 1 introduces the capability of different energy service providers to encode identification signals—i.e., a signature or watermark—into power flows generated at their respective plants 103. The identification signal is detected as power from the grid is consumed at the consumer site 117. By decoding the identification signals, pertinent information regarding the identification signal is conveyed to the consumer, including the identity of the provider of the various power flows distributed over the grid 101. Based on this identification, the consumer can specify their power consumption preferences, including indicating which of the different energy types and providers they prefer to receive power from. Resultantly, the distribution of power to the consumer site 117 may be adapted based on individual or collective aggregation of consumer preference data by the grid provider, the energy providers, or a combination thereof in near real-time.

In certain embodiments, the identification signal is generated by an encoder mechanism 105a-105f that employs various signal encoding schemes for pseudo-randomly producing orthogonal signals. By way of example, orthogonality of an identification signal pertains to the perpendicular, non-overlapping and uncorrelated nature of one identification signal (of one provider or brand) produced at one plant 103a versus the identification signal produced at another plant 103d. An encoder mechanism 105a-105f is configured for operation at each plant 103a-103f for facilitating generation of identification signals on a pseudorandom (causal) basis, thus supporting adaptation of the identification signal as well as deterministic monitoring of the signal over time. Each identification signal is therefore unique and subject to change for security, monitoring and authentication purposes—i.e., as facilitated by way an energy management module 131. The energy management module 131 also facilitates maintenance of a list of the various identification signals and/or associated pseudorandom code information for access by consumers.

For the purpose of illustration, the encoder mechanism 105a-105f of a respective site/plant 103a-103f of the energy service provider modulates the original power signal/flow using code division multiple access (CDMA). It is noted, however, that any other multiplexing, channel access, data encoding, modulation, watermarking or other approach can be employed for enabling asynchronous or synchronous signal processing. The encoder mechanism 105 may be implemented as a hardware and/or software based signal modulator.

The encoder mechanism 105 employs CDMA for spreading orthogonal or pseudorandom code—corresponding to the identification signal—uniformly over the same bandwidth as the original power signal. For example, this includes multiplying the different power flows at respective plants 103a-103f by a pseudorandom code sequence; each code being unique for every different encoder 105a-105f. This pseudorandom code sequence may be based, at least in part, on a static unique identifier value of the energy provider, while another portion of the code sequence is pseudorandom. For either approach, there is sufficient separation between the different identification signals—i.e., the cross-correlations of the respective signals is zero as power flows are transmitted via the grid 101. It is noted that the code, or identification signal, is generated by respective encoders 105a-105f to run at a higher rate (frequency) than their counterpart power signals over the same bandwidth. In certain embodiments, the energy management module 131 maintains a record of the locally generated identification signal produced at each plant/site 103 accordingly for decoding purposes.

In certain embodiments, the identification signal of a particular energy provider may also be imprinted with identification data, which includes one or more of the following: data for uniquely identifying the energy provider (e.g., a brand or company name), data for specifying the source of the various power flows into the grid (e.g., location, region, grid entry point), data for indicating the energy types upon which the power is based (e.g., wind, solar, water), data for indicating the type of producer/energy provider from which the power is derived (e.g., nuclear energy producer), data for indicating an environmental impact and/or metric related to the power being consumed (e.g., a carbon footprint), or a combination thereof. The identification data may be associated with identification signal as metadata. It is noted, in certain instances, that the source information may be synonymous with the name of the energy provider. Alternatively, the source information may be used to track the source of power flows and/or the points of entry of a power flow onto the grid 101—i.e., a location of a transmission substation 107. For a single or multi-grid configuration, the source information distinguishes the locality or different sectors of the grid 101 accordingly.

Power flows from the plants 103a-103f are transmitted by the grid 101 and subsequently distributed to respective consumer sites 117a-117d. In certain embodiments, the power grid may be configured with one or more encoding repeaters 111a-111n. The encoding repeaters 111a-111n re-encode the one or more identification signals as the power flows from respective plants 103a-103f are combined and subsequently propagated across the various components of the electrical power grid. As noted previously, the component of the grid may include one or more transformers, power lines, substations, etc. It is noted that the encoding repeaters 111a-111n may be integrated into the grid for use every X miles of power transmission, thus minimizing distortion of the identification signals over long distances. Also, the encoding repeaters 111a-111n may be monitored and/or controlled by the energy management module 131, for supplying the recorded pseudorandom and/or orthogonal code required to generate the identification signals.

In certain embodiments, the consumer sites are equipped with decoder mechanisms 115a-115d for enabling identification signals to be decoded by the consumer as power is drawn from the grid 101. Under this scenario, the decoder mechanism 115a-115d is configured to communicate with the energy management module 131 via the network for supporting the decoding. This includes, for example, processing of the power flow from the grid 101 to extract/parse out the different identification signals and interpreting the encoded information specified by the signals based on the records maintained by the module 131.

The decoder mechanism 115 communicates with the energy management module 131 to receive the pseudorandom code used to generate the various identification signals. By way of example, the code is maintained by the energy management module 131 as part of a record or list of all relevant/active codes for the various energy providers. The pseudorandom code may be transmitted to the decoder mechanism 115 by the energy management module 131 pursuant to a decoding request, such as via the network 106. Under this scenario, the pseudorandom code corresponding to an identification signal may be received by way of an internet connection. Alternatively, the code may be transmitted to the decoder mechanism 115 via a dedicated control channel through which the list of relevant/active codes is accessed. It is noted that the relevancy or active status of a code, and thus the identification signal, may be depreciated over time for affecting the decoding capability of the decoder mechanism 115. By way of example, codes may be removed from the list and thus restricted from being interpreted via a network modem to prevent excessive growth of the pseudorandom code list. This ensures the cycle time for identification of a code from the list is not excessive.

In certain embodiments, the decoder calculates the cross-correlations of the identification signals of the known energy providers 103a-103f with the actual power delivered/consumed at the consumer site 117a-117d. If the pseudorandom sequences do not match a particular signal, then the signal appears as useless noise and no correlation is determined. When a match is determined to within a predetermined threshold of correlation, the decoder mechanism 115 extracts the identification signal from the power signal and translates the code for rendering to a user interface. The results of the decoding may be shared with the energy management module 131, which further facilitates rendering of the identification information via a user interface.

It is noted that the decoder mechanism 115 may be implemented as hardware and/or software based signal demodulator; adapted accordingly for enabling presentment of the identification information to a user interface for review by a consumer. In addition to decoding, the decoder mechanism 115 may also determine and report back current power use and consumption by the consumer. For example, as power is consumed, the decoder mechanism 115a-115d reports the company and current power usage—i.e., via the grid 101—thus enabling the grid 101 provider to predict near time consumption. This predictive analysis enables the grid provider to compensate for power flow shortages as well as prevent oscillations in the grid 101 network based on real-time usage parameters.

In addition, the decoder mechanism 115a-115d of the respective consumer sites 117a-117d enables consumer to specify, use, select and/or filter only those power flows determined to be associated with an energy type, provider, source, environmental metric or brand of their liking. This corresponds to one or more consumer preferences, which are specified by the user via the interface. Preferences are reported to the energy management module 131 and correspond to execution of various algorithms/filters for affecting power consumption at the customer site 117. In certain embodiments, power distribution is adapted based on the preferences in near real-time or at a later time at the discretion of the provider of the grid 101.

By way of example, the interface may feature an option for enabling the consumer to specify a preference for a particular type of power or energy source. As another option, the consumer may provide an input for specifying a CO2 imprint value they want to achieve or fall below. Still further, the consumer may filter out any service providers that rely on the generation of a particular energy source, or select an ideal percentage allocation of energy to be provided by the respective energy providers and/or sources.

In certain embodiments, the energy management module 131 communicates with the encoder mechanisms 105a-105f and decoder mechanisms 115a-115d for (1) receiving customer preferences and feedback information; (2) receiving current customer site 117a-117d power consumption rates; (3) receiving updated pseudorandom and/or orthogonal code information for use in generating identification signals; (4) receiving identification information as metadata to be imprinted/encoded with an identification signal; or (5) a combination thereof. In certain embodiments, communication of the above described information is facilitated over a communication network 106.

While power grid 101 implementations may vary, the energy management module 131 may also be (optionally) directly integrated into the grid 101 as a component of the grid distribution and/or transmission network. Under this scenario, the energy management module 131 employs various assemblies, connectors and/or other integration means for monitoring power flows throughout the grid 101, at the production site/plant 103, at various substations 107 and 113, at the consumer site 117 or the like. This integration may be performed in connection with network based communication means for supporting real-time power flow, power consumption and consumer feedback monitoring of the grid 101. Alternatively, information may be exchanged via the various components of the grid 101, i.e., transmission of the above data via existing power lines.

In the case of network based communication, the communication network 106 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

By way of example, the encoders 105, decoders 115 and energy management module 131 communicate with each other and other components of the communication network 106 using well known, new or still developing protocols. In this context, a protocol includes a set of rules defining how the network nodes within the communication network 106 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

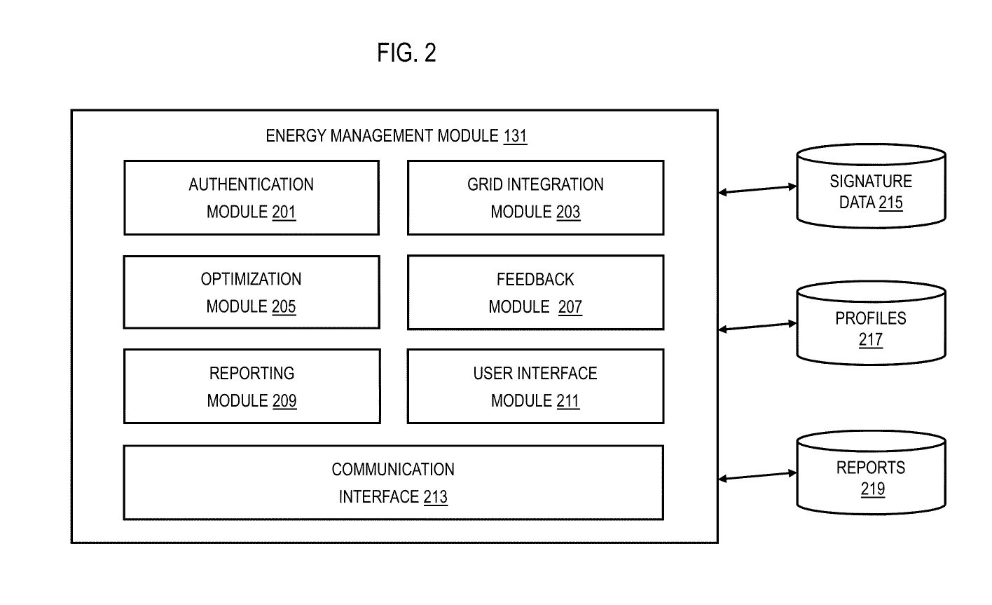

FIG. 2 is a diagram of an energy management module 131, according to one embodiment. The energy management module 131 includes various executable modules for performing one or more computing, data processing and network based instructions that in combination provide a means of enabling consumers to identify the different types and sources of power being distributed over an electrical power grid. Such modules can be implemented in hardware, firmware, software, or a combination thereof. Also, as noted previously, the various modules may be integrated for use within the framework of a power grid 101 and integrated with various components of the grid. By way of example, the energy management module 131 may include authentication module 201, grid integration module 203, optimization module 205, feedback module 207, reporting module 209, user interface module 211 and communication interface 213.

In addition, the energy management module 131 also accesses identification data and associated metadata from a signature database 215. The signature data may correspond to the list of pseudorandom codes for use in connection with various decoding mechanisms 115. In addition, the module 131 accesses profile information regarding one or more consumers, energy providers, or other users of the grid 101 from a profile database 217. Still further, the module 131 maintains reports, such as those generated by the reporting module 209, in a reports database 219.

In one embodiment, an authentication module 201 authenticates consumers as well as energy providers for interaction with the energy management module 131. By way of example, the authentication module 201 receives a request to subscribe to the energy management module for enabling energy providers to encode their power flows with a unique identification signal, i.e., for watermarking purposes. As another example, a consumer may subscribe with the authentication module 201 to enable installing and activation of a decoder mechanism for use at their consumer site. The subscription process may include the establishing of various default settings or preferences, such as default energy source preference for the consumer and metadata configuration for the energy provider. Preferences and settings information may be referenced to a specific consumer, energy provider (e.g., company), brand, or combination thereof, and maintained as profile data 217.

Profile data 217 for respective subscribers, which contains pertinent consumer or device profile data, may be established via a login process with the module 103 (e.g., via the user interface module 211). Once subscribed, subsequent login attempts result in cross referencing of the profile data. Alternatively, the login process may be performed through automated association of profile settings maintained as registration data with an IP address, a carrier detection signal of an encoder and/or decoder mechanisms, a device identification number or other identifier.

Still further, the authentication module 201 may also be configured to receive and validate signals as received by respective encoder and/or decoder mechanisms. This may include, for example, verifying a device and/or software identifier value or a network/internet protocol address as specified during a communication session between the encoder and/or decoder mechanisms and the energy management module 131 via the communication network 106. Validation of the signal prevents spoofing or fictitious generation of identification signals and/or consumer preference data—thus ensuring authenticity of data conveyed to the consumer, the energy providers and the provider of the grid 101. The validation process may be performed in connection with various data encryption and/or decryption techniques for further securing the information exchanged with the energy management module 131.

It is noted that the authentication module 201, pursuant to validation of a signal, may also trigger execution of the various other modules for initiating fulfillment of requests per interaction with the encoder and/or decoder mechanisms configured to the grid 101. Signals are received by way of the communication interface 213.

In one embodiment, the grid integration module 203 determines generation of an identification signal by way of an encoding mechanism of a subscribed energy provider. Once generated, the grid integration module 203 requests and/or automatically receives the pseudorandom code sequence used to generate the orthogonal identification signal (e.g., specific waveform information such as frequency, amplitude, bit sequences, etc.). In addition, the grid integration module 203 receives metadata as imprinted and/or otherwise associated with the identification signal. As noted previously, the metadata may include data for specifying a name or brand of the energy provider, an energy type, an energy source, an environmental impact factor or metric, etc. This information is then maintained for subsequent retrieval as signature data 215.

The grid integration module 203 also communicates with the various decoders configured at the consumer site for supporting the ability of consumers to decipher the received identification signals. For example, when a decode request is received from a decoder mechanism at the consumer site, the grid integration module 203 retrieves the current/required pseudorandom code sequence information. It then packages this information and sends it to the decoder mechanism for execution of the decoding of the various signals. The grid integration module 203 may cause a pushing or pulling of identification signal data and identification information on demand, or periodically, for maintaining current records of modulated signals.

In one embodiment, the optimization module 205 processes the preferences specified by various consumers based on one or more optimization policies, algorithms, or filter generated by the producer for affecting power consumption at one or more consumer sites based on the preferences. Processing may include, for example, determining a preferred consumer energy usage at various levels of geographic and/or consumer market and/or site granularity, identifying a preferred environmental emissions rate at various levels of granularity, optimal energy pricing and grid capacity based on preferred energy consumption, preferred partnerships with other energy providers based on consumer demand, etc. As noted, the optimizations may vary from one energy provider or grid provider to the next. It is noted that the optimization module 205 may operate in connection with the user interface module 211 for receiving preference input data from the consumer, which are provided as variables for enabling the optimization to be performed.

The optimization module 205 is also configured to perform predictive analysis, deterministic analysis and other procedures based on processing of the consumer preferences information, power consumption ratings for the consumer sites, grid and/or infrastructure intelligence, historical power consumption and input models, etc. The results of such analysis may be compiled into one or more reports by the reporting module 209 and stored to the reports database 219 for subsequent analysis. Alternatively, the reporting module 209 may interact with the user interface module 211 for enabling reports to be presented to a user interface of the energy service provider, grid provider, etc. By way of this approach, the consumer or energy service provider may be able to perform near real-time viewing of the results relative to current grid performance factors. Still further, the report may cause the triggering of an adaptation of power flows from the energy producers by the grid provider.

In one embodiment, the feedback module 207 is triggered for execution by the optimization module 205 for enabling automatic adapting of power flows at a particular consumer site, a collection of consumer sites, a specific region, a specific sector of the power grid 101, etc., in response to determined preferences. By way of example, a consumer preference for achieving a certain carbon footprint may cause a reduction in the amount of power consumed, or automated selection of specific energy providers, sources, or types commensurate with the consumer requirement. From the perspective of the energy provider, a determined boost in demand for wind energy may cause the adaptation of power flows by a company who processes wind energy sources (if programmatically enabled by the provider), or at least, initiation of a request for increased production.

It is noted that the feedback module 207 may interact enable the passage of signals for initiating an adaptation over the grid 101. This may be performed in connection with the grid integration module 203. Alternatively, the feedback module 207 may execute various functions for controlling the components of the grid—i.e., relays, substations, transformers, repeaters, etc.

In one embodiment the user interface module 211 enables presentment of a graphical user interface for enabling adaptation of consumer preference, presenting optimization analysis results, viewing consumer consumption and preferences data, etc. By way of example, the user interface module 211 generates the interface in response to application programming interfaces (APIs) or other function calls corresponding to a browser application or web portal application of a device used to access the network 106 or grid 101. As such, the user interface module 211 permits the display of graphics primitives for enabling consumer input and interaction with the energy management module 131.

In one embodiment, a communication interface 213 enables formation of a session over a network 106 between the energy management module 131 and a browser or other UI means (e.g., as provided by an encoder and/or decoder mechanism). By way of example, the communication interface 213 executes various protocols and data sharing techniques for enabling collaborative execution between the encoder mechanisms, decoder mechanisms and the energy management module 131 over the network 106. Still further, the communication interface 213 may implement consumer access to a control channel for accessing of a list of pseudorandom code information pertaining to various energy provider identification signals.

It is noted that the above presented modules and components of the energy management module 131 can be implemented in hardware, firmware, software, or a combination thereof. In another embodiment, one or more of the modules 201-213 may be implemented for operation by respective encoder and/or decoder mechanisms as a platform, hosted solution, cloud-based solution, or a combination thereof

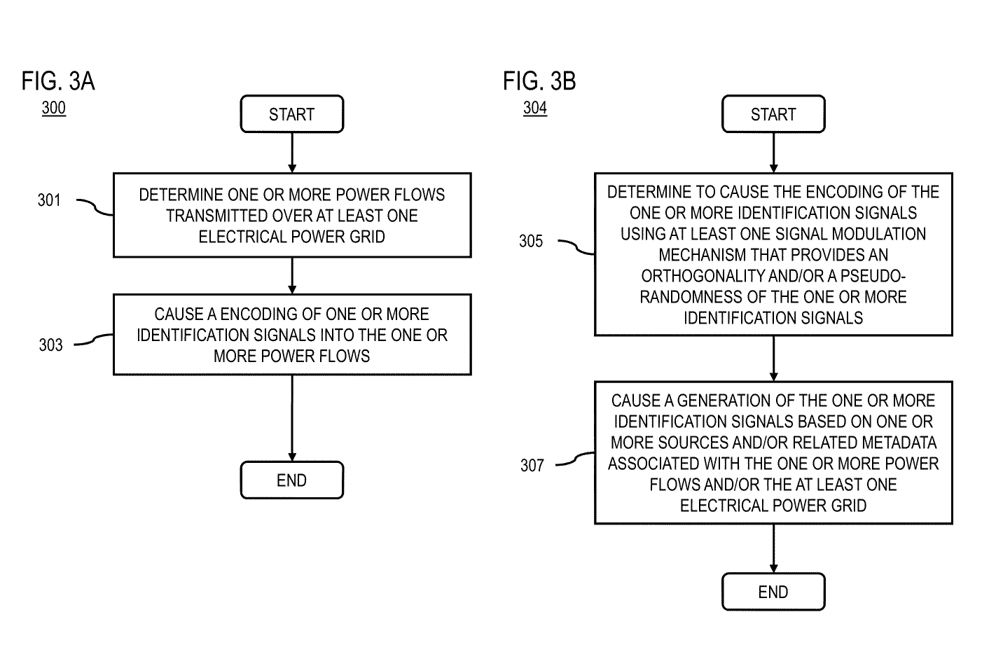

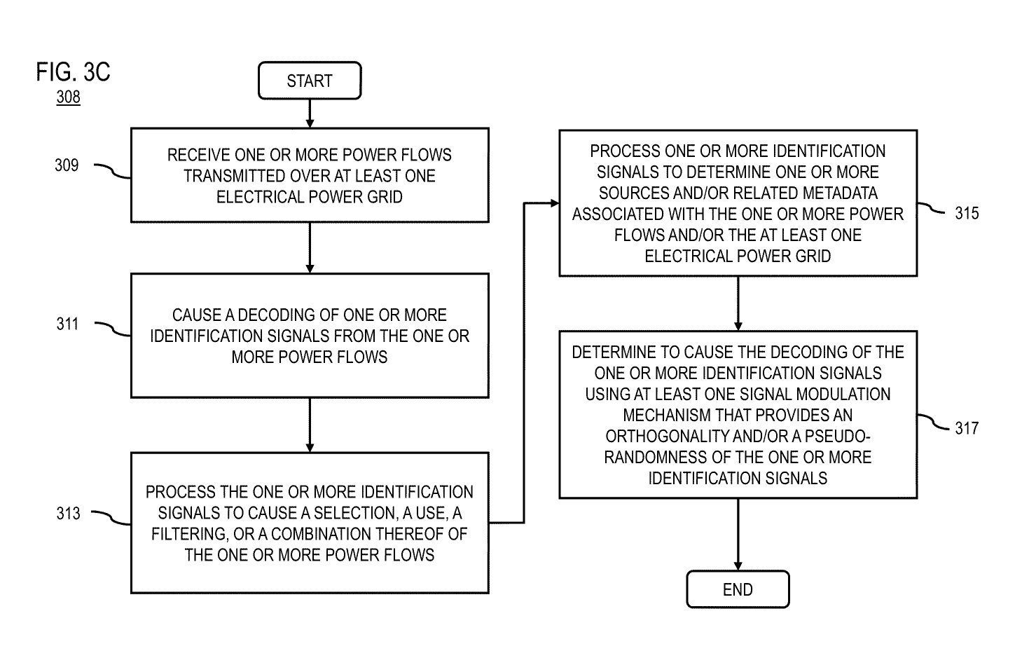

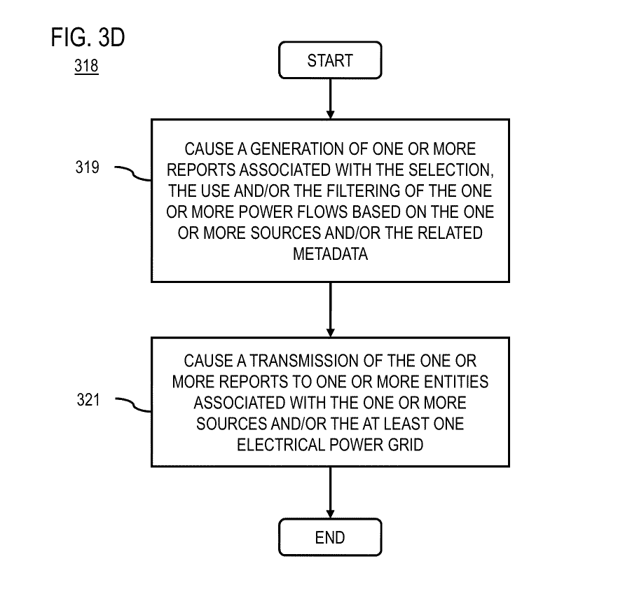

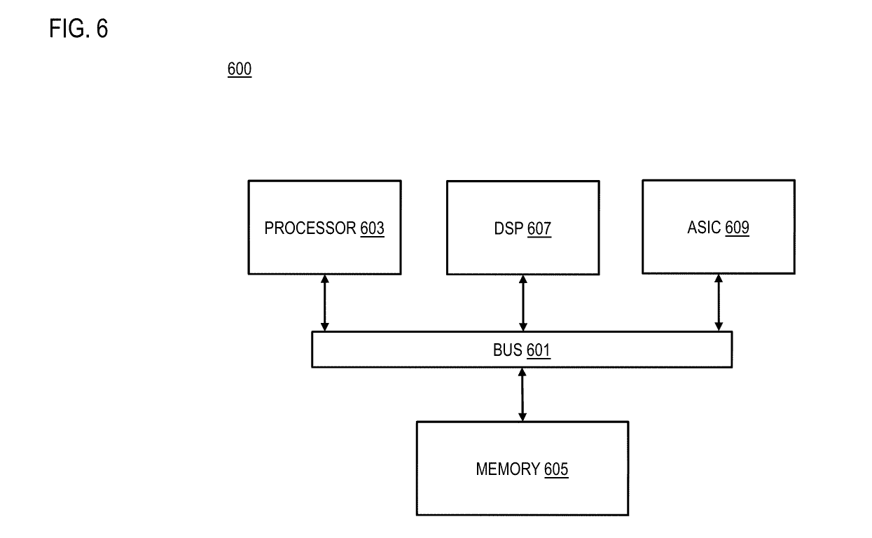

FIGS. 3A-3D are flowcharts of processes for enabling consumers to identify the different types and sources of power being distributed over an electrical power grid, according to one embodiment. In one embodiment, the energy management module 131 operates in connection with the encoder mechanism 105 to perform processes 300, 304, while the decoder mechanism 115 performs various steps of processes 308 and 318. These processes are implemented in, for instance, a chip set including a processor and a memory as shown in FIG. 6.

In step 301, the energy management module 131 determines one or more power flows transmitted over at least one electrical power grid. As noted, the power flows are provided by a number of different energy providers for transmission and distribution over a grid. In another step 303, the module 131 causes a encoding of one or more identification signals into the one or more power flows. The one or more identification signals distinguish the one or more power flows from one or more other power flows transmitted over the at least one electrical power grid.

In step 305 of process 304 (FIG. 3B), the energy management module 131 determines to cause the encoding of the one or more identification signals using at least one signal modulation mechanism that provides an orthogonality and/or a pseudo-randomness of the one or more identification signals. In step 307, the module 131 causes a generation of the one or more identification signals based on one or more sources and/or related metadata associated with the one or more power flows and/or the at least one electrical power grid. As noted previously, the encoding may be based on code division multiple access or any other technique for enabling transmission of and modulation of power flow signals for supporting consumer end identification. Also, the metadata associated with a given identification signal may include data for identifying the source of a power flow, the provider of a power flow, the energy type associates with a power flow, an environmental impact and/or metric associated with the power flow, etc.

In step 309 of process 308 (FIG. 3C), the decoder mechanism 115 receives one or more power flows transmitted over at least one electrical power grid. In another step 311, the decoder mechanism 115 causes a decoding of one or more identification signals from the one or more power flows. As noted, the decoding may include correlating the identification signals using the same pseudorandom sequence as recorded by the energy management module 131. Per step 313, the decoder mechanism 115 processes the one or more identification signals to cause a selection, a use, a filtering, or a combination thereof of the one or more power flows. In certain embodiments, this includes causing a blocking of certain power flows based on a filtering out of the power flow pursuant to a consumer preference.

In step 315, the decoder mechanism 115 processes one or more identification signals to determine one or more sources and/or related metadata associated with the one or more power flows and/or the at least one electrical power grid. The metadata may be used for enabling the consumer to distinguish between characteristics of the various power flows and to support execution of one or more preferences. Per step 317, the decoder mechanism 115 determines to cause the decoding of the one or more identification signals using at least one signal modulation mechanism that provides an orthogonality and/or a pseudo-randomness of the one or more identification signals.

In step 319 of process 318 (FIG. 3D), the decoder mechanism 115 causes a generation of one or more reports associated with the selection, the use and/or the filtering of the one or more power flows based on the one or more sources and/or the related metadata. In another step 321, the decoder mechanism 115 causes a transmission of the one or more reports to one or more entities associated with the one or more sources and/or the at least one electrical power grid. As noted, the reports may include a combination of near-real time statistics, analysis results, historical data, etc.

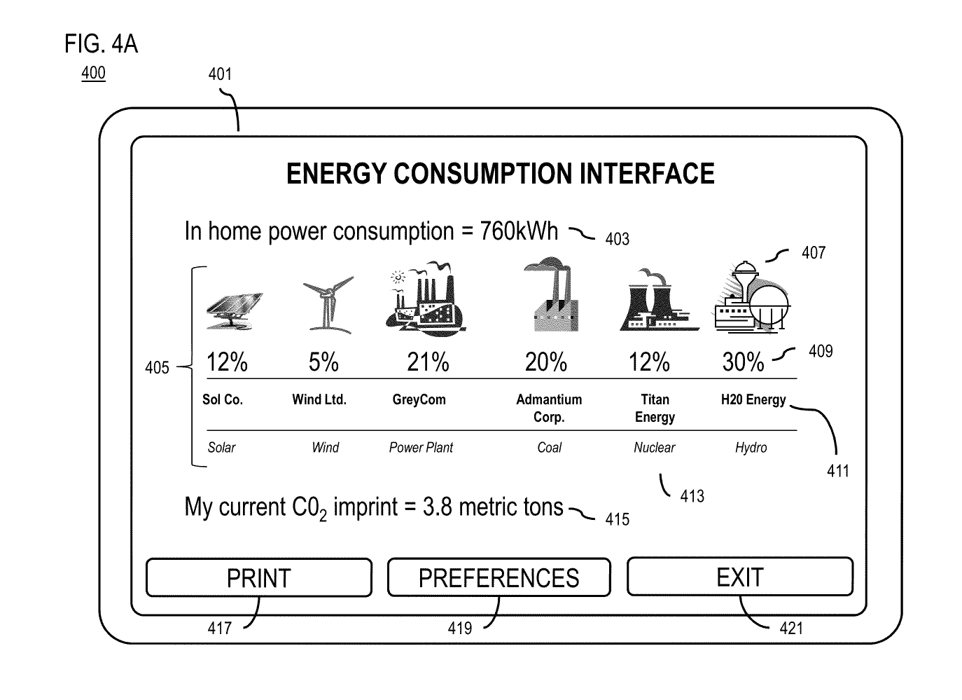

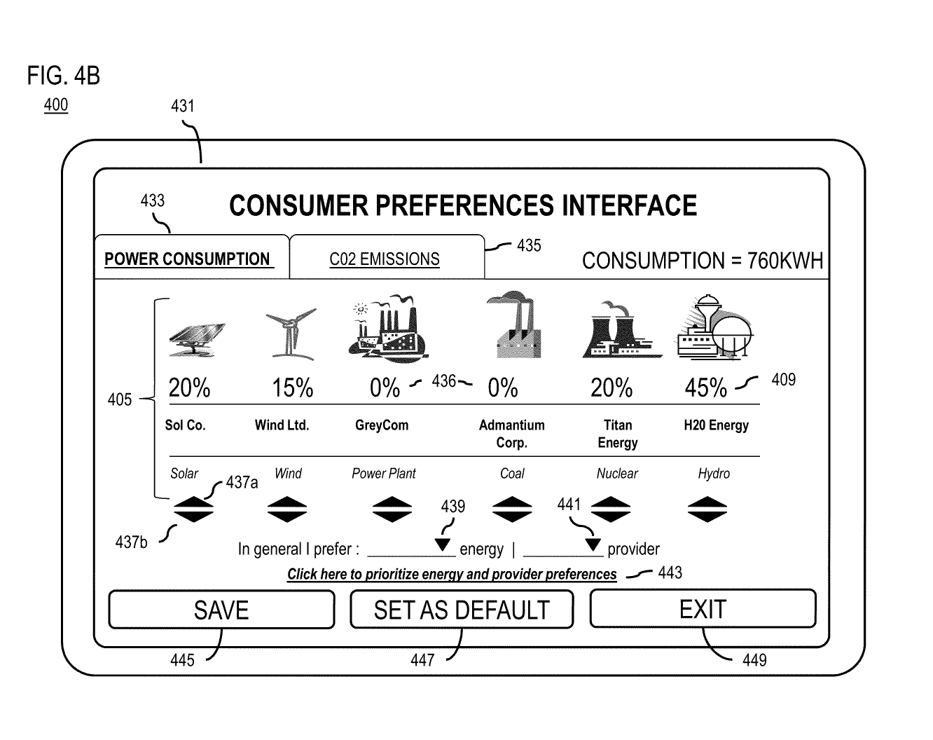

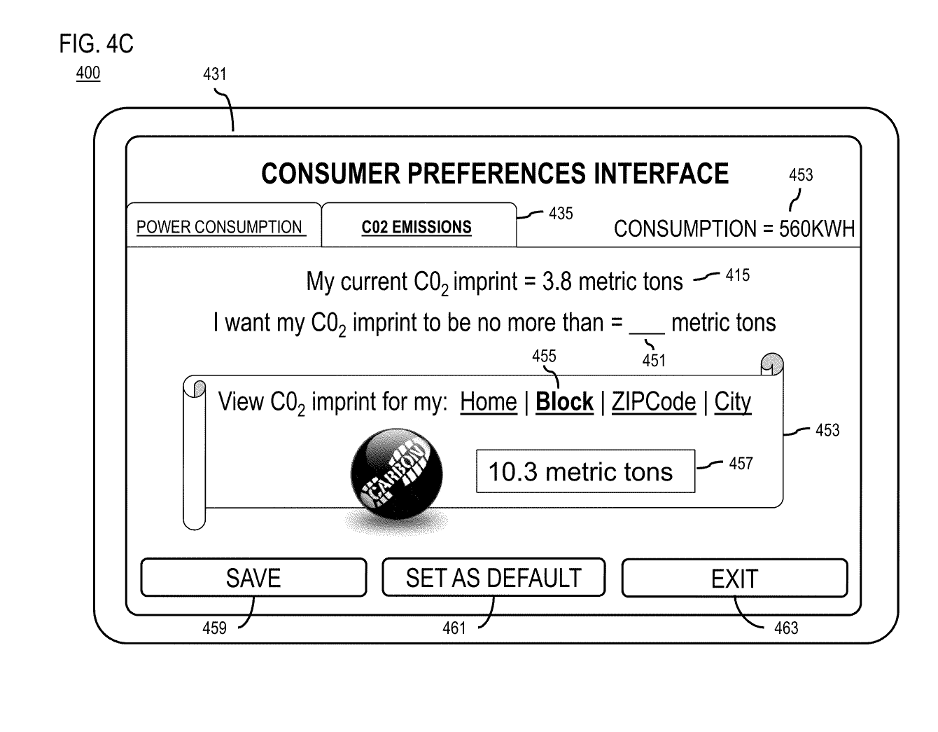

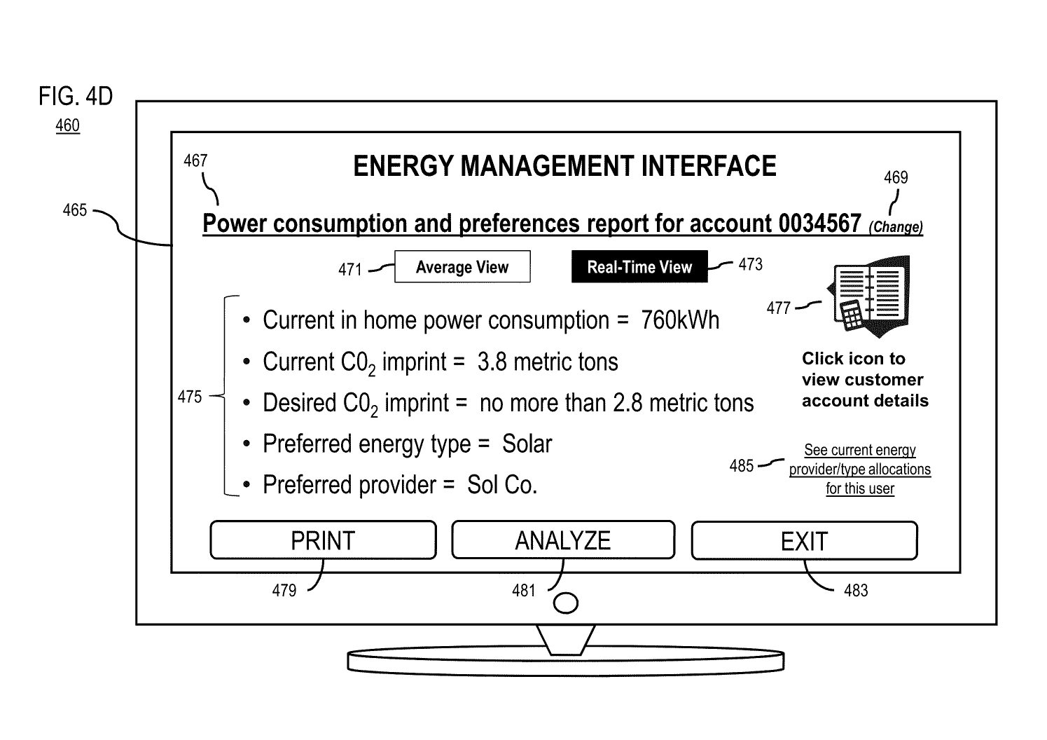

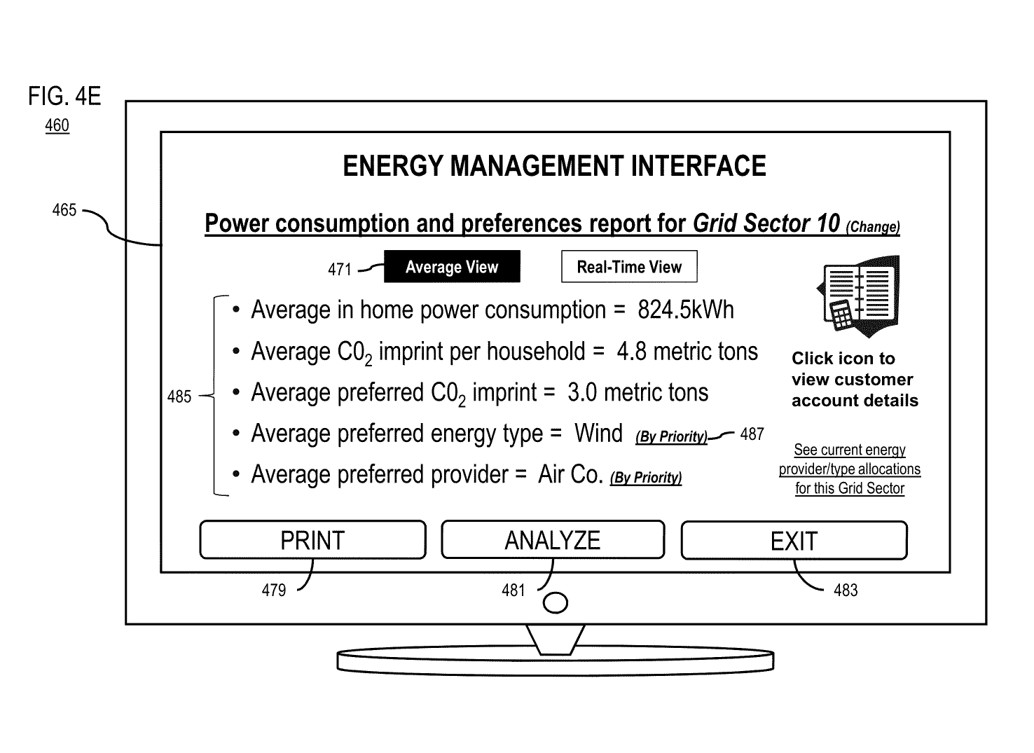

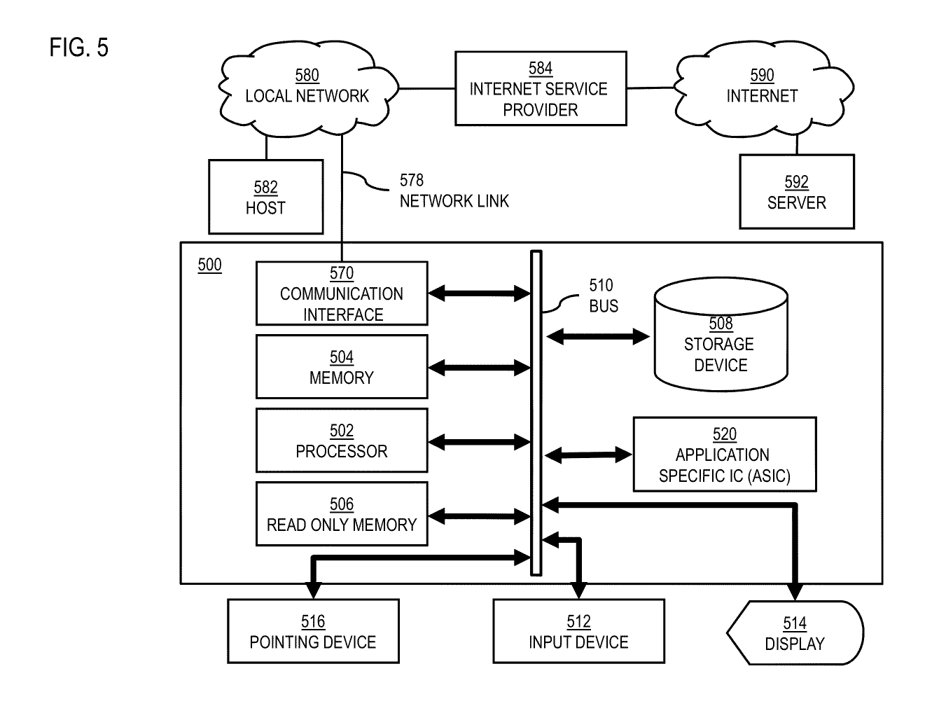

FIGS. 4A-4E are diagrams of user interfaces utilized in the processes of FIGS. 3A-3D, according to various embodiments. For the purpose of illustration, the diagrams are described with respect to an exemplary use case of a consumer that consumes electrical energy supplied by way of a power grid. The energy is provided by various different providers and corresponds to different energy sources and types. It is noted that the user interface depictions may correspond to a browser interface rendered to a computer display 400, a dedicated metering device display 400 (e.g., of the encoder and/or decoder mechanisms 105 and 115), or other display for presenting data and reports to the consumer and energy provider.

In FIG. 4A, a consumer accesses an energy consumption interface 401 as supported and/or rendered, at least in part, on data provided by the energy management module 131. The interface 401 presents the current in home power consumption of a consumer. In the case of the consumer site being a factory, commercial building or other type of premise, the language used to convey the power consumption is adapted accordingly, i.e., “Power consumption of your business=”).

Also rendered to the interface is identification information for providing the consumer with characteristic data 405 regarding their power consumption. In addition, the characteristic data includes information extracted as a result of the decoding of one or more identification signals associated with the power being consumed. As noted previously, the identification information is retrieved by the energy management module 131 as metadata associated with an identification signal. By way of example, the identification signals convey various icons for indicating the category of the energy provider (e.g., a hydro-electric power plant icon 407), a name (e.g., 411) of the energy provider and an energy type 413 associated with the energy provider. For each of the different power flows, a percentage value (e.g., 409) is presented for representing what percentage of the overall power consumption 403 the associated energy type corresponds to. Under this scenario, for example, the hydro plant owned by H20 Energy comprises 30% of the overall energy consumption value 403.

The consumer is also presented with an environmental value 415, which in this case corresponds to a carbon footprint/imprint generated by the consumer based on their determined power consumption 403. Once the consumer reviews the interface, they may select various action buttons including a PRINT action button 417 for printing the information, a PREFERENCES action button 419 for activating a consumer preferences interface 431 (FIG. 4B) and an EXIT action button 421 for exiting the interface 401. Upon selection of the PREFERENCES action button 419, user interface 431 is presented.

The consumer preferences interface 431 allows the consumer to select one or more preferences for affecting and/or adapting their power consumption, the various characteristic data regarding their power consumption, or a combination thereof. In this example, the interface 431 is divided into two views as represented by view tabs 433 and 435. Tab 433 renders a power consumption preferences view while tab 435 renders a CO₂ emissions preferences view. When the consumer selects the power consumption preferences tab 433, the same characteristic data 405 as presented in interface 401 is shown. However, in addition, the consumer is also presented with various UP and DOWN action buttons (e.g., 437a and 437b respectively) for enabling the consumer to alter the percentage of power they consume with respect to a particular energy provider and/or energy type. By way of example, if the consumer prefers to use more solar energy, they would select the UP action button 437 to increase the current consumption percentage of 20% to the desired value. The consumer would perform the same action for the various other providers and/or energy types listed. Under this scenario, the consumer adapts various of the different categories when compared to the original consumption percentages of FIG. 4A. This includes, for example, effectively blocking out (e.g., zero percentage value 436) any power produced by GreyCom and Admantium Corp., producers of power provided by an electrical power plant and coal based processing plant respectively.

Also presented is a menu selection option button 439 for enabling a consumer to select from a single energy type as a key preference. In addition, a menu selection option button 441 is presented for enabling a consumer to select from a single energy provider as a key preference and/or source. By way of example, the key energy type preference list includes the various energy types presented as part of the characteristic data 405, which includes solar, wind, power plant (electric), coal, nuclear and hydro-electric. Upon selection of an option, the percentage values (e.g., percentage value 409) are dynamically altered to reflect the selection based on an allocation prescribed by the energy management module 131. Under this scenario, the energy type indicated as the key preference will reflect the highest percentage value. Alternatively, the preference is simply recorded, and the consumer is still able to alter the percentage values manually.

A similar action may occur as a result of consumer selection of a key provider preference. For example, when the consumer selects H20 Energy as their key provider preference, the percentage value of power derived from this provider is increased (if not already so). It is noted that the consumer may select both a key provider preference and/or key energy type preference accordingly. Also, the consumer may activate a link 443 for enabling prioritization of the various energy types, energy providers, energy sources, etc. By way of this approach, when a first priority preference selection is not feasible due to technical and/or business reasons associated with the grid provider and/or energy provider, the subsequent priority options are honored. Once finished, the consumer can opt to save their preference settings by selecting a SAVE action button 445, set the preference setting as default by selecting a DEFAULT action button 447, or exit the interface 431 by selecting an EXIT action button 449.

In FIG. 4C, the CO₂ emissions view is presented to the consumer preference interface 431, corresponding to selection of view tab 435. The consumer is presented with their current environmental value 415, along with an option to manually input a desired environmental value at a data entry field 451. In certain embodiments, when the consumer inputs a value and selects the SAVE action button 459, the energy consumption value 453 is adapted accordingly (e.g., a projected value required to meet the preferred environmental value 457).

The consumer is also presented with one or more links (e.g., the Block link 455) for enabling the consumer to view an environmental value 457 at varying degrees of granularity. The level of granularity made available for selection will vary depending on the range and scope of the grid 101. Under this scenario, the levels of granularity and corresponding links include Home, Block 455, ZIPCode and City. Once the various selections are made, the consumer can once again save them, set them as default preferences, or exit the interface 431 via action buttons 459, 461 and 463.

The energy management module 131 monitors and receives the input provided by the consumer via interface 431 for performing analysis, initiating adaptations to current power flows for the consumer, etc. Consequently, a preference selection may immediately impact the power flow and/or consumption rate to the consumer or affect future distribution of power by the grid provider, the energy provider, or both. It is noted that the energy management module 131 may opt to record preferences, but prevent/restrict adaptation of power flows based on known grid and/or network conditions, energy provider issues, etc.

FIGS. 4D and 4E depict an energy management interface 465 as rendered to a computer display 460 of a grid provider (or representative thereof). The provider is presented with various information regarding current/real-time power consumption by one or more consumers, details pertaining to the grid 101, etc., such as in the form of a report. For example, information 467 is shown for indicating the report pertains to a specific consumer account—i.e., as referenced via profile data. The grid provider can change the account number, and thus the current view, by selecting the Change link 469. While not shown, selection of this link invokes a window for enabling grid provider to select different accounts, consumers, or groups to report at varying levels of granularity. For example, the grid provider may select a different consumer account to view, a group of consumers associated by geographic location or energy type preference, a number of accounts configured to a particular sector of the grid 101, etc. The grid provider may also click on icon 477 for retrieving the profile information associated with a selected consumer, a registered group of consumers, etc.

For the purpose of illustration, the grid provider may select an Average View or Real-Time View action button 471 and 473 respectively for altering the details 475 of the report. Under this scenario, the Average View action button 471 causes a rendering of average consumption and preferences details 475 for the selected account to be presented. The period of time over which the averages are shown may be altered at the discretion of the grid provider; the average view being useful for observing the power consumption and/or preference selection tendencies of the consumer over a period of time. The Real-Time View action button 473 causes a rendering of the current/real-time consumption and preferences details 475. By way of example, the details may include a current power consumption value of the consumer, a current environmental value of the consumer, a desired/preferred environmental value, a preferred energy type, and a preferred energy provider. The grid provider may also select a link 485 to view the energy consumption details—i.e., specific percentages—selected by the consumer.

In FIG. 4E, a report is presented for conveying consumption and preferences details 485 for a different consumer or group thereof. Under this scenario, the details 485 correspond to Grid Sector 10, which includes multiple different consumers configured to receive power from the grid from a specific sector/location/source. Also, the consumer selects the Average View action button 471 for adapting the values presented as detail 485. Hence, the average power consumption value and environmental value for the group is shown. In addition, the average preference selections, based on the consensus of the individual consumers associated with the group, are shown. The grid provider can select a link 487 for viewing the prioritized averages, i.e., the average prioritization of energy types as selected among the various consumers comprising the group.

The grid provider can print the report by selecting the PRINT action button 479, initiate analysis of the details 475 based on one or more algorithms of executions via an ANALYZE action button 481, or exit the interface 465 by selecting the EXIT action button 483.

The exemplary method and system discussed herein enables various advantages for the grid provider, consumer and energy provider. For example, one advantage is that the consumer usage and preference reports allow the grid provider to analyze energy production and usage patterns over the grid in real-time. As another advantage, by performing analysis of the data the grid provider and energy provider can optimize and tune electricity production, thus avoiding the procurement and/or generation of power that does not meet the consumer's needs or general demand requirements.

As yet another advantage, by watermarking the power flows at the point of production and enabling them to be deciphered by the consumer, consumers may actually distinguish between the various providers, sources and types of energy they consume. As such, consumer preferences may be properly accounted for and adapted to for maximum efficiency of the grid and the consumer. This includes performance of real-time detection and prevention of anomalies in the distribution or transmission network.

Also, the above described method and systems enables more effective green and sustainable energy strategies to be developed and/or refined at varying levels of granularity and/or business or community involvement (e.g., a City-wide Go Green for a Day initiative). Still further, producers of energy of different types and/or derived from different sources can access measurable statistics and facts for supporting business and marketing initiatives by geographic area.

The processes described herein for enabling consumers to identify the different types and sources of power being distributed over an electrical power grid may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to enable consumers to identify the different types and sources of power being distributed over an electrical power grid as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of enabling consumers to identify the different types and sources of power being distributed over an electrical power grid.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to enable consumers to identify the different types and sources of power being distributed over an electrical power grid. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for enabling consumers to identify the different types and sources of power being distributed over an electrical power grid. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for enabling consumers to identify the different types and sources of power being distributed over an electrical power grid, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 106 for enabling consumers to identify the different types and sources of power being distributed over an electrical power grid to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to enable consumers to identify the different types and sources of power being distributed over an electrical power grid as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of enabling consumers to identify the different types and sources of power being distributed over an electrical power grid.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable consumers to identify the different types and sources of power being distributed over an electrical power grid. The memory 605 also stores the data associated with or generated by the execution of the inventive steps.

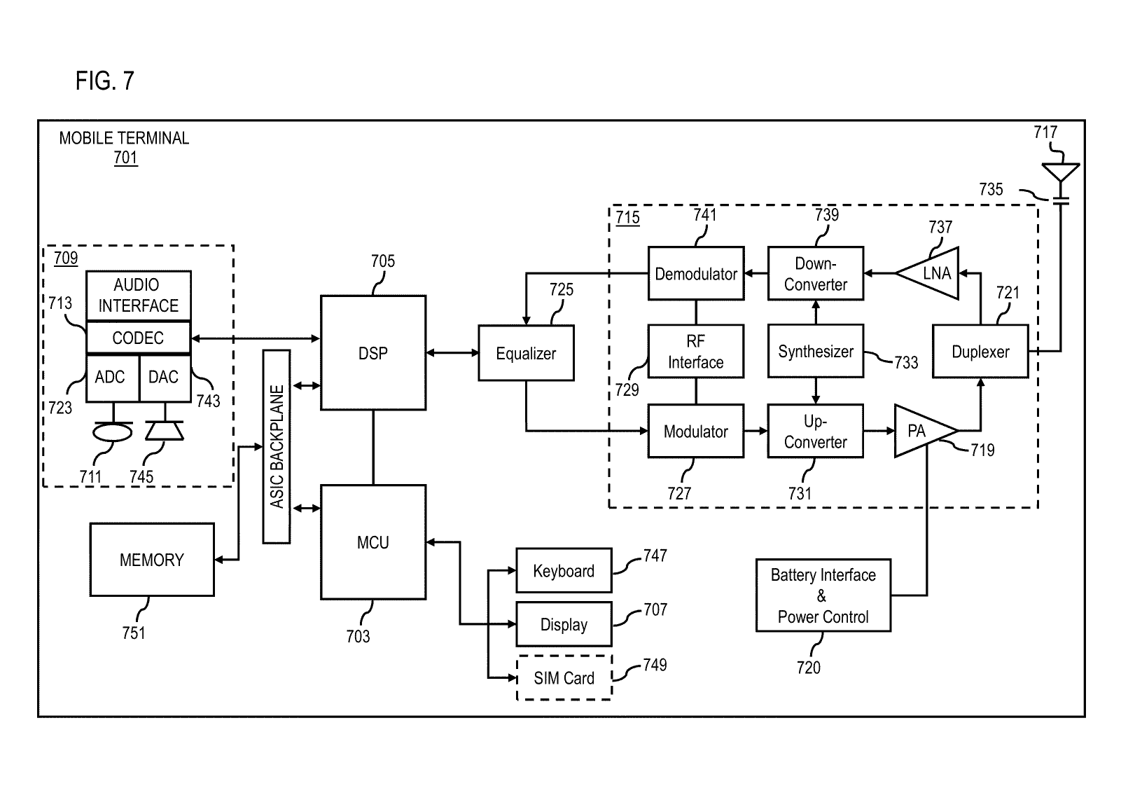

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of enabling consumers to identify the different types and sources of power being distributed over an electrical power grid. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of enabling consumers to identify the different types and sources of power being distributed over an electrical power grid. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to enable consumers to identify the different types and sources of power being distributed over an electrical power grid. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more power flows transmitted over at least one electrical power grid; and
an encoding of one or more identification signals into the one or more power flows,
wherein the one or more identification signals, at least in part, distinguish the one or more power flows from one or more other power flows transmitted over the at least one electrical power grid.

2. A method of claim 1, wherein the (1) data and/or (2) information and/or (3) at least one signal are further based, at least in part, on the following:
at least one determination to cause, at least in part, the encoding of the one or more identification signals using at least one signal modulation mechanism that provides, at least in part, an orthogonality, a pseudorandomness, or a combination thereof of the one or more identification signals.

3. A method of claim 2, wherein the at least one signal modulation mechanism includes, at least in part, a code division multiple access (CDMA) mechanism.

4. A method of claim 1, wherein the (1) data and/or (2) information and/or (3) at least one signal are further based, at least in part, on the following:
a generation of the one or more identification signals based, at least in part, on one or more sources, related metadata, or a combination thereof associated with the one or more power flows, the at least one electrical power grid, or a combination thereof.

5. A method of claim 4, wherein the related metadata thereof include, at least in part, one or more energy types, one or more energy producer types, one or more environmental impacts, one or more brands associated with the one or more sources, or a combination thereof

6. A method of claim 1, wherein the at least one electrical power grid comprises, at least in part, one or more encoding repeaters; wherein the one or more encoding repeaters re-encode the one or more identification signals across one or more components of the at least one electrical power grid; and wherein the one or more components include, at least in part, one or more transformers.

7. A method comprising facilitating a processing of and/or processing (1) data and/or (2) information and/or (3) at least one signal, the (1) data and/or (2) information and/or (3) at least one signal based, at least in part, on the following:
a reception of one or more power flows transmitted over at least one electrical power grid;
a decoding of one or more identification signals from the one or more power flows; and
a processing of the one or more identification signals to cause, at least in part, a selection, a use, a filtering, or a combination thereof of the one or more power flows.

8. A method of claim 7, wherein the (1) data and/or (2) information and/or (3) at least one signal are further based, at least in part, on the following:
a processing of the one or more identification signals to determine one or more sources, related metadata, or a combination thereof associated with the one or more power flows, the at least one electrical power grid, or a combination thereof.

9. A method of claim 8, wherein the (1) data and/or (2) information and/or (3) at least one signal are further based, at least in part, on the following:
a generation of one or more reports associated with the selection, the use, the filtering, or a combination thereof of the one or more power flows based, at least in part, on the one or more sources, the related metadata, or a combination thereof and
a transmission of the one or more reports to one or more entities associated with the one or more sources, the at least one electrical power grid, or a combination thereof

10. A method of claim 7, wherein the (1) data and/or (2) information and/or (3) at least one signal are further based, at least in part, on the following:
at least one determination to cause, at least in part, the decoding of the one or more identification signals using at least one signal modulation mechanism that provides, at least in part, an orthogonality, a pseudo-randomness, or a combination thereof of the one or more identification signals,
wherein the at least one signal modulation mechanism includes, at least in part, a code division multiple access (CDMA) mechanism.

11. An apparatus comprising:
at least one processor; and
at least one memory including computer program code for one or more programs,
the at least one memory and the computer program code configured to, with the at least one processor, cause the apparatus to perform at least the following,
determine one or more power flows transmitted over at least one electrical power grid; and
cause, at least in part, an encoding of one or more identification signals into the one or more power flows,
wherein the one or more identification signals, at least in part, distinguish the one or more power flows from one or more other power flows transmitted over the at least one electrical power grid.

12. An apparatus of claim 11, wherein the apparatus is further caused to:
determine to cause, at least in part, the encoding of the one or more identification signals using at least one signal modulation mechanism that provides, at least in part, an orthogonality, a pseudorandomness, or a combination thereof of the one or more identification signals.

13. An apparatus of claim 12, wherein the at least one signal modulation mechanism includes, at least in part, a code division multiple access (CDMA) mechanism.

14. An apparatus of claim 11, wherein the apparatus is further caused to:
cause, at least in part, a generation of the one or more identification signals based, at least in part, on one or more sources, related metadata, or a combination thereof associated with the one or more power flows, the at least one electrical power grid, or a combination thereof

15. An apparatus of claim 14, wherein the related metadata thereof include, at least in part, one or more energy types, one or more energy producer types, one or more environmental impacts, one or more brands associated with the one or more sources, or a combination thereof.

16. An apparatus of claim 11, wherein the at least one electrical power grid comprises, at least in part, one or more encoding repeaters; wherein the one or more encoding repeaters re-encode the one or more identification signals across one or more components of the at least one electrical power grid; and wherein the one or more components include, at least in part, one or more transformers.

17. An apparatus comprising:
at least one processor; and
at least one memory including computer program code for one or more programs, the at least one memory and the computer program code configured to, with the at least one processor, cause the apparatus to perform at least the following,
receive one or more power flows transmitted over at least one electrical power grid;
cause, at least in part, a decoding of one or more identification signals from the one or more power flows; and
process and/or facilitate a processing of the one or more identification signals to cause, at least in part, a selection, a use, a filtering, or a combination thereof of the one or more power flows.

18. An apparatus of claim 17, wherein the apparatus is further caused to:
process and/or facilitate a processing of the one or more identification signals to determine one or more sources, related metadata, or a combination thereof associated with the one or more power flows, the at least one electrical power grid, or a combination thereof.

19. An apparatus of claim 18, wherein the apparatus is further caused to:
cause, at least in part, a generation of one or more reports associated with the selection, the use, the filtering, or a combination thereof of the one or more power flows based, at least in part, on the one or more sources, the related metadata, or a combination thereof; and
cause, at least in part, a transmission of the one or more reports to one or more entities associated with the one or more sources, the at least one electrical power grid, or a combination thereof.

20. An apparatus of claim 17, wherein the apparatus is further caused to:
determine to cause, at least in part, the decoding of the one or more identification signals using at least one signal modulation mechanism that provides, at least in part, an orthogonality, a pseudo-randomness, or a combination thereof of the one or more identification signals,
wherein the at least one signal modulation mechanism includes, at least in part, a code division multiple access (CDMA) mechanism.

21-48. (canceled)
